(19) United States
(12) Patent Application Publication
(10) Pub. No.: US 2019/0235747 A1
(43) Pub. Date: Aug. 1, 2019

(54) GESTURE NAVIGATION SYSTEM OF ELECTRONIC DEVICE

(71) Applicant: InFoucus Precision Industry (Shenzhen) Co. Ltd, Shenzhen (CN)

(72) Inventor: NING CUI, Shenzhen (CN)

(21) Appl. No.: 16/246,463

(22) Filed: Jan. 12, 2019

(30) Foreign Application Priority Data
Jan. 12, 2018 (CN) 201810033591.0

(51) Int. Cl. G06F 3/0488; G06F 3/0484

(52) U.S. Cl. CPC G06F 3/04883; G06F 2203/04808; G06F 3/0484; G06F 3/04886

(57) ABSTRACT

An electronic device includes a display screen, a processor, and a memory. The processor detects a sliding touch gesture on the display screen, confirms a corresponding command of the sliding touch gesture according to a start point, an end point, and a sliding distance “S” of the sliding touch gesture, and executes a function of the corresponding command.

### FIELD

The subject matter herein generally relates to electronic devices, and more particularly to a gesture navigation system of an electronic device.

### BACKGROUND

Generally, touch displays of electronic devices require a physical keyboard attached to the electronic device or a virtual keyboard displayed on the touch display to control functions of the electronic device. The virtual keyboard takes up space of the touch display, and the physical keyboard takes up hardware space of the electronic device.

### BRIEF DESCRIPTION OF THE DRAWINGS

Implementations of the present disclosure will now be described, by way of example only, with reference to the attached figures.

FIG. 1 is a block diagram of an embodiment of an electronic device including a gesture navigation system.

FIG. 2 is a diagram of a portrait orientation of a display screen of the electronic device in FIG. 1.

FIG. 3 is a diagram of a landscape orientation of the display screen of the electronic device in FIG. 1.

FIG. 4 is a block diagram of function modules of the gesture navigation system in FIG. 1.

FIG. 5 is a flowchart of a gesture navigation method.

FIG. 6 is a diagram of a designated area of the display screen in the portrait orientation.

FIG. 7 is a diagram of the designated area of the display screen in the landscape orientation.

FIG. 8 is a flowchart of a method for setting a first predetermined value, a second predetermined value, and a third predetermined value of corresponding sliding distances for executing corresponding commands of the gesture navigation system.

FIG. 9 is a flowchart of a method for calibrating the first predetermined value, the second predetermined value, and the third predetermined value.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

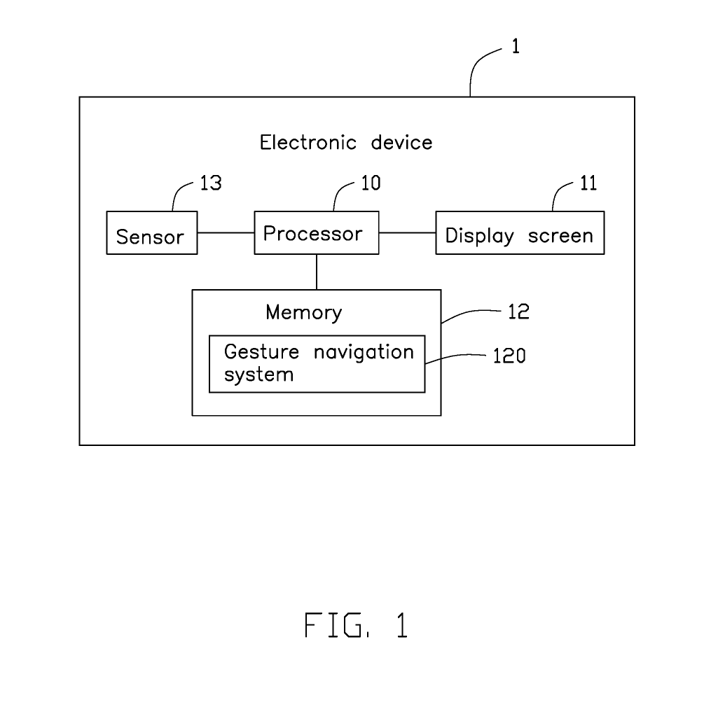

FIG. 1 illustrates an embodiment of an electronic device. The electronic device 1 may be a mobile game, a mobile phone, a tablet computer, or other device having touch functionality. In at least one embodiment, the electronic device 1 includes, but is not limited to, a processor 10, a display screen 11, a memory 12, and a sensor 13. The processor 10, the display screen 11, the memory 12, and the sensor 13 are electrically coupled together.

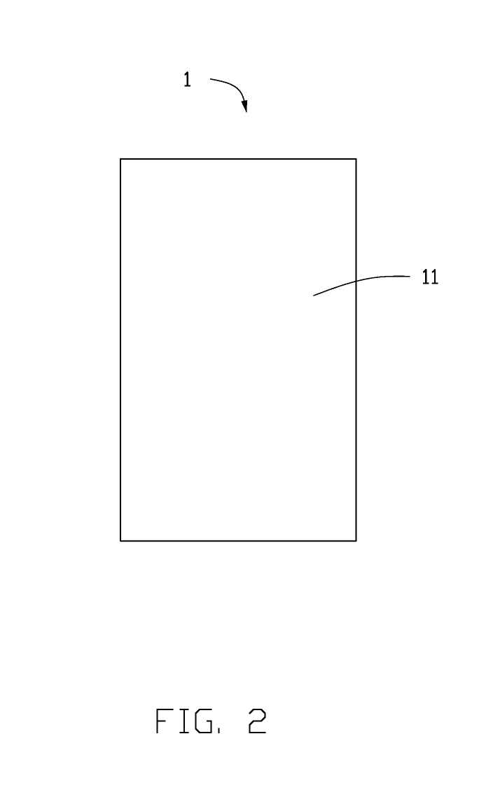

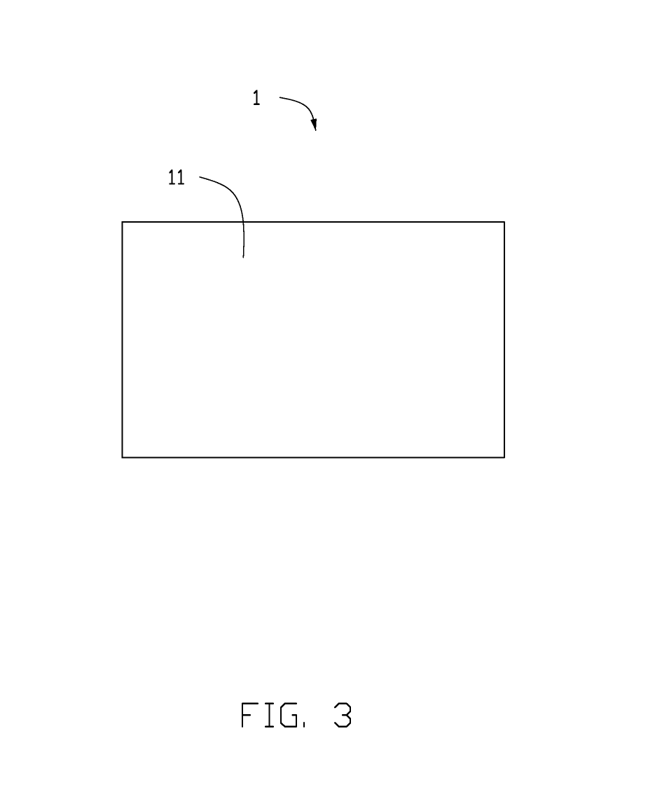

In at least one embodiment, the display screen 11 is a touch screen. The sensor 13 senses an orientation of the display screen 11 as a portrait orientation or a landscape orientation. For example, when the display screen 11 is placed in the orientation illustrated in FIG. 2, the sensor 13 senses that the display screen 11 is in the portrait orientation. When the display screen 11 is placed in the orientation illustrated in FIG. 3, the sensor 13 senses that the display screen 11 is in the landscape orientation.

In at least one embodiment, the sensor 13 may be a gravitational sensor, or a gravitational sensor coupled to another sensor, such as a compass sensor and/or a gyroscope.

In at least one embodiment, the memory 12 stores a plurality of instructions and a plurality of data, such as for a gesture navigation system 120. The memory 12 may includes a read-only memory, a random access memory, a programmable read-only memory, an erasable programmable read-only memory, a one-time programmable read-only memory, an electrically-erasable programmable read-only memory, a compact disc read-only memory, or other disk storage device, magnetic storage device, magnetic tape storage device, or other portable storage medium.

In at least one embodiment, the processor 10 may include a central processing unit, a microprocessing unit, a data processing chip, or graphics processing chip, or other control chip module. The processor 12 can execute the plurality of instructions stored in the memory 12 to implement functions of the gesture navigation system 120.

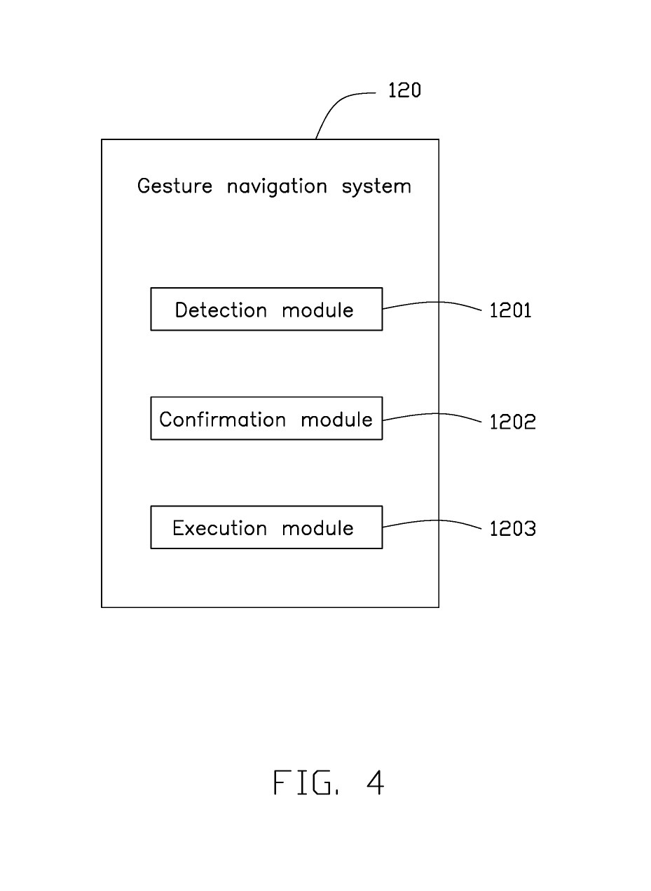

In at least one embodiment, the gesture navigation system 120 includes a plurality of modules stored in the memory 12 and executed by the processor 10. For example, FIG. 4 shows that, the plurality of modules may include a detection module 1201, a confirmation module 1202, and an execution module 1203.

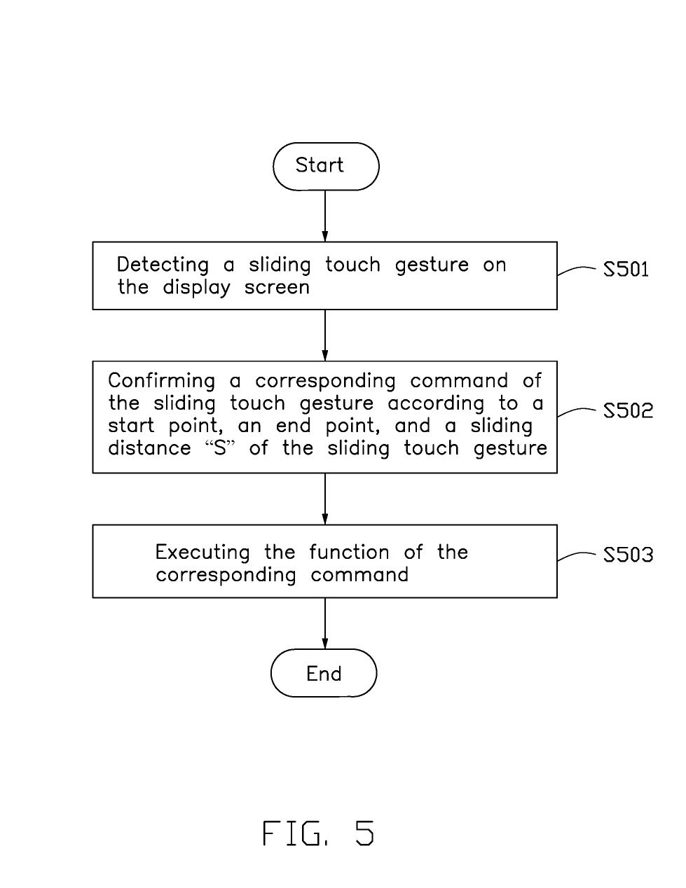

FIG. 5 illustrates a flowchart of a gesture navigation method. The example method is provided by way of example, as there are a variety of ways to carry out the method. The method described below can be carried out using the configurations illustrated in FIGS. 1-4, for example, and various elements of these figures are referenced in explaining the example method. Each block shown in FIG. 5 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block S501.

At block S501, the detection module 1201 detects a sliding touch on the display screen 11. When the detection module 1201 detects a sliding touch on the display screen 11, block S502 is implemented.

At block S502, the confirmation module 1202 confirms a corresponding command of the sliding touch according to a start point, an end point, and a sliding distance “S” of the sliding touch operated on the display screen 11.

In at least one embodiment, when the start point of the sliding touch is located within a designated area of the display screen 11, the sliding distance “S” is greater than a first predetermined value (such as 3.5 cm), and the sliding touch does not hover on the end point, the confirmation module 1202 confirms that a first command corresponds to the sliding touch.

In at least one embodiment, when the start point of the sliding touch is located within the designated area of the display screen 11, the sliding distance “S” is less than the first predetermined value and greater than a second predetermined value, and the sliding touch does not hover on the end point, the confirmation module 1202 confirms that a second command corresponds to the sliding touch. The second predetermined value may be set to be equal to a height of the predetermined area, such as 0.2 cm.

In at least one embodiment, when the start point of the sliding touch is located within the designated area of the display screen 11, the sliding distance “S” is greater than a third predetermined value, and the sliding touch hovers on the end point for a predetermined time duration (such as 1 second), the confirmation module 1202 confirms that a third command corresponds to the sliding touch. The third predetermined value may be greater than or equal to the second predetermined value.

In at least one embodiment, the sliding distance “S” of the sliding touch is calculated according to a coordinate of the start point (X1, Y1) and a coordinate of the end point of the sliding (X2, Y2). In one embodiment, the sliding distance “S” is calculated according to the formula S=Y2−Y1. In another embodiment, the sliding distance is calculated according to the formula

S=\sqrt{(X1−X2)²+(Y1−Y2)²}.

In at least one embodiment, the three commands correspond to different navigation functions of the electronic device 1. For example, the first command corresponds to a function of a “home button” to control the electronic device 1 to display a home page on the display screen 11. The second command corresponds to a function of a “back button” to control the electronic device 1 to display a previous interface on the display screen 11. The third command corresponds to a function of a “recent button” to control the electronic device 1 to display all opened applications and interface in a list on the display screen 11.

In at least one embodiment, when the start point of the sliding touch is not located within the predetermined area of the display screen 11, the confirmation module 1202 confirms that the sliding touch corresponds to a normal command of the electronic device 1. The normal command may be any command excluded by the three commands of the gesture navigation system 120. For example, the normal command may be a sliding touch to turn a page, move an interface, or the like.

In at least one embodiment, the confirmation module 1202 confirms that a touch or a sliding touch that occurs only within the designated area is an ineffective command. The touch or the sliding touch is confirmed to occur only within the designated area when every coordinate point of the touch or the sliding touch is located within the designated area.

In at least one embodiment, the designated area is located at a bottom portion of the display screen 11 in a current display mode of the display screen 11, such as in the landscape mode or the portrait mode. The designated area includes a predetermined shape and size. For example, the designated area includes a designated width W1 and height H1, and the shape of the designated area is rectangular. For example, the designated height may be 0.2 cm. For ease of explanation, the width refers to the horizontal length of the designated area, and the height refers to the vertical length of the designated area.

In at least one embodiment, to prevent accidental touch operations, a predetermined distance X is defined between a left edge of the display screen 11 and a left edge of the designated area and between a right edge of the display screen 11 and a right edge of the designated area. For example, X is equal to 0.5 cm. In this way, the width of the designate area W1 is equal to W2-2X, where W2 is the width of the display screen 11. In another embodiment, W1=W2, and X=0.

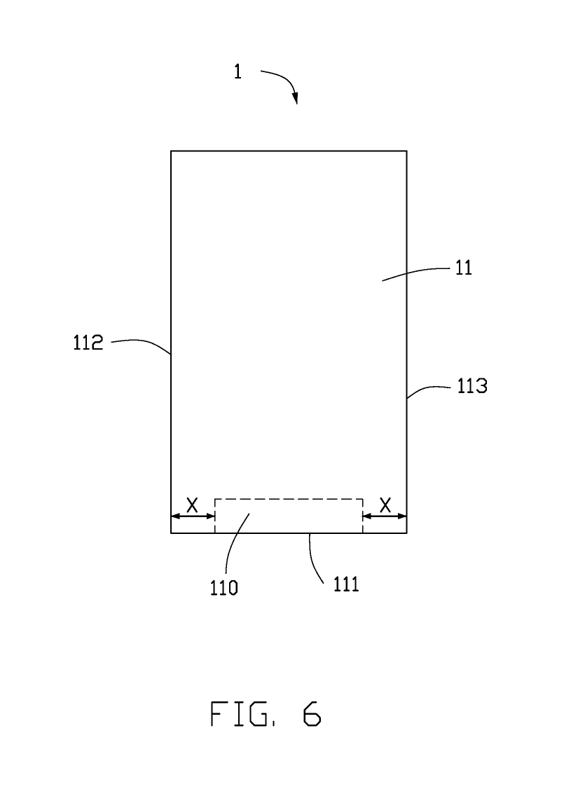

For example, FIG. 6 show that when the display screen 11 is in the portrait orientation, a designated area 110 is located near a bottom side 111 of the display screen 11. The predetermined distance X is defined between a left side 112 of the display screen 11 and the designated area 110 and between a right side 113 of the designated area 110 and the designated area 110.

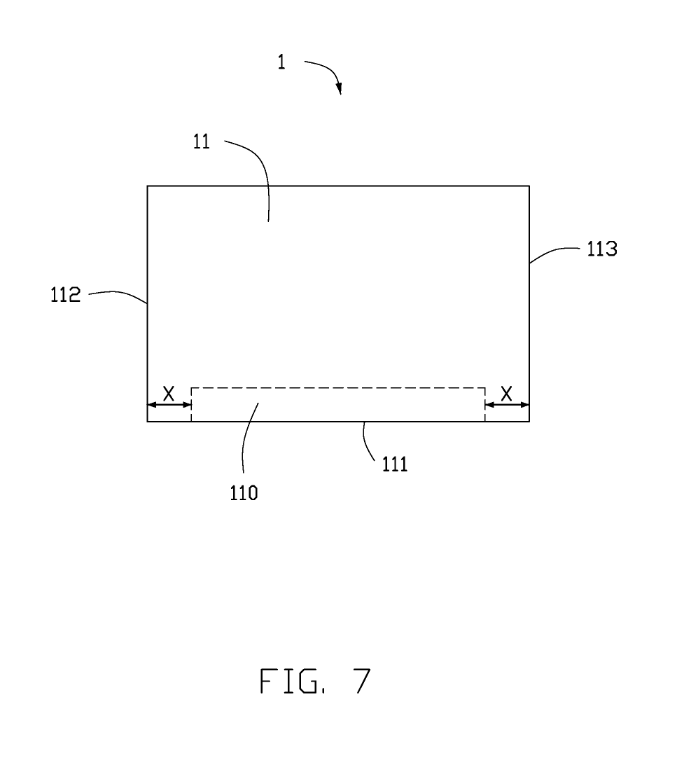

For example, FIG. 7 shows that when the display screen 11 is in the landscape orientation, a designated area 110 is located near a bottom side 111 of the display screen 11. The predetermined distance X is defined between a left side 112 of the display screen 11 and the designated area 110 and between a right side 113 of the designated area 110 and the designated area 110.

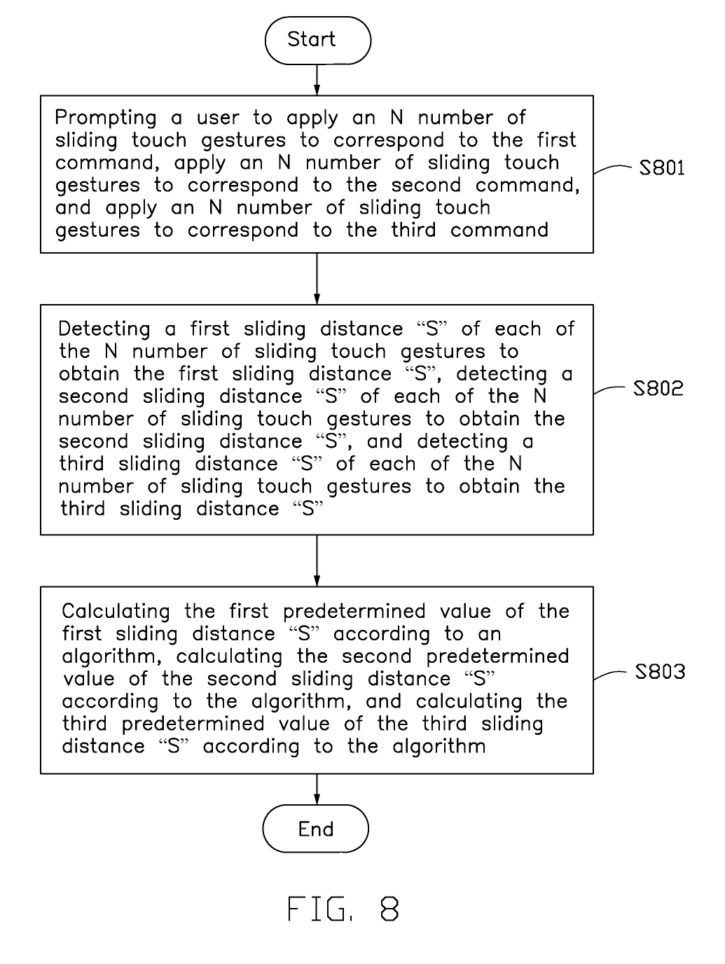

The first predetermined value, the second predetermined value, and the third predetermined value may be set by a system administrator of the gesture navigation system 120. In another embodiment, the first predetermined value, the second predetermined value, and the third predetermined value may be confirmed by the confirmation module 1202 according to user input. In detail, refer to FIG. 8.

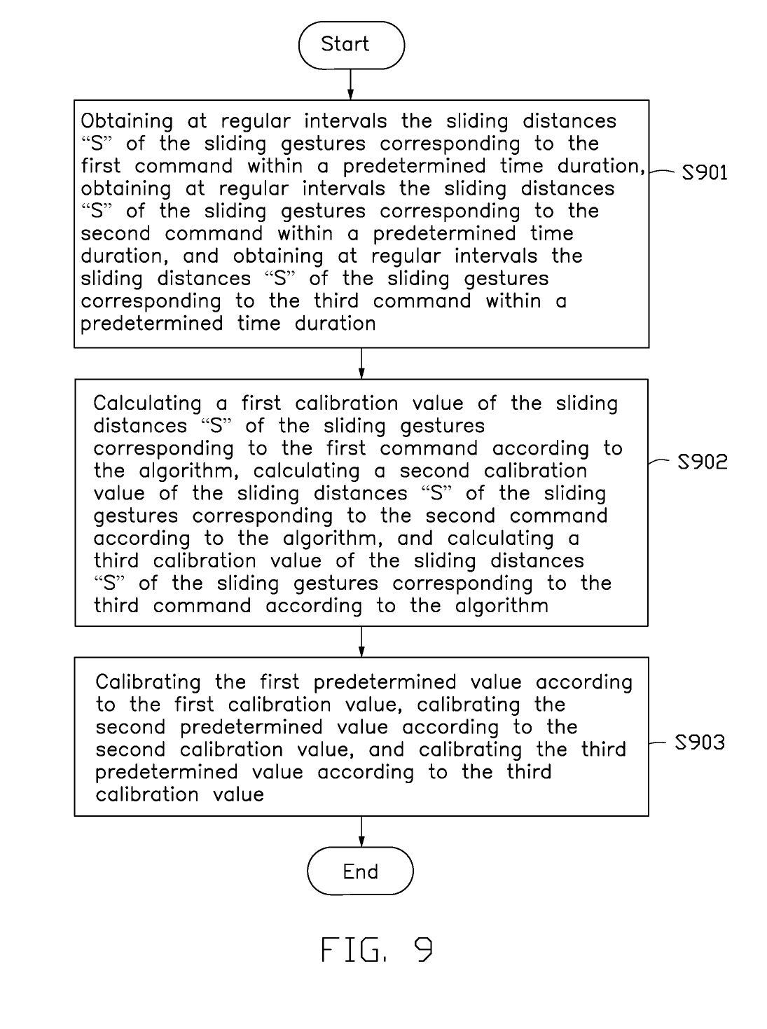

The first predetermined value, the second predetermined value, and the third predetermined value may further be calibrated according to use of the gesture navigation system 120 as illustrated in FIG. 9.

In at least one embodiment, when the sliding touch is confirmed to correspond to the first command, the confirmation module 1202 stores the first command, the sliding distance “S”, and a corresponding time of the first command in the memory 12. In at least one embodiment, the confirmation module 1202 confirms the time of the first command according to a system time of the electronic device 1 and stores the time of the first command as the system time.

Similarly, when the sliding touch is confirmed to correspond to the second command, the confirmation module 1202 stores the second command, the sliding distance “S”, and a corresponding time of the second command in the memory 12. When the sliding touch is confirmed to correspond to the third command, the confirmation module 1202 stores the third command, the sliding distance “S”, and a corresponding time of the third command in the memory 12.

The confirmation module 1202 stores the corresponding command, the sliding distance “S”, and the corresponding time of the corresponding command for calibrating the first predetermined value, the second predetermined value, and the third predetermined value. For details, refer to FIG. 9.

At block S503, the execution module 1203 executes the function of the corresponding command confirmed by the confirmation module.

For example, when the first command is confirmed, the execution module 1203 controls the electronic device 1 to display the home interface on the display screen 11.

For example, when the second command is confirmed, the execution module 1203 controls the electronic device 1 to display the previous interface on the display screen 11.

For example, when the third command is confirmed, the execution module 1203 controls the electronic device 1 to display all of the opened applications and interfaces in a list on the display screen 11.

For example, when the normal command is confirmed, the execution module 1203 executes the normal function of the normal command.

It should be stated that when the ineffective command is confirmed, the execution module 1203 does not execute any function or prompts a user with text or audio to take a corresponding action.

FIG. 8 illustrates a flowchart of a method for setting the first predetermined value, the second predetermined value, and the third predetermined value. The example method can begin at block S801.

At block S801, the confirmation module 1202 prompts a user to apply an N number of sliding touches to correspond to the first command, apply an N number of sliding touches to correspond to the second command, and apply an N number of sliding touches to correspond to the third command. N is a positive integer number, such as 5, 10, 15, or 20.

In at least one embodiment, the confirmation module 1202 issues the corresponding prompt during an initial time of using the electronic device 1 after purchase.

At block S802, the confirmation module 1202 detects a first sliding distance “S” of each of the N number of sliding touches to obtain the first sliding distance “S” of each of the N number of sliding touches. The confirmation module 1202 detects a second sliding distance “S” of each of the N number of sliding touches to obtain the second sliding distance “S” of each of the N number of sliding touches. The confirmation module 1202 detects a third sliding distance “S” of each of the N number of sliding touches to obtain the third sliding distance “S” of each of the N number of sliding touches.

At block S803, the confirmation module 1202 calculates the first predetermined value of the first sliding distance “S” according to an algorithm. The confirmation module 1202 calculates the second predetermined value of the second sliding distance “S” according to the algorithm. The confirmation module 1202 calculates the third predetermined value of the third sliding distance “S” according to the algorithm.

In at least one embodiment, the algorithm may calculate the corresponding predetermined value according to a minimum value, an average value, or a weighted average value. For example, in at least one embodiment, the first predetermined value is an average value of the N number of sliding touches, the second predetermined value is an average value of the N number of sliding touches, and the third predetermined value is an average value of the N number of sliding touches.

In another embodiment, the first predetermined value is a minimum value of the N number of sliding touches, the second predetermined value is a minimum value of the N number of sliding touches, and the third predetermined value is a minimum value of the N number of sliding touches.

It should be stated that in at least one embodiment, the confirmation module 1202 first prompts the user to apply the N number of sliding touches corresponding to the first predetermined value. After the confirmation module 1202 calculates the first sliding distance “S” according to the N number of sliding touches corresponding to the first predetermined value, the confirmation module 1202 further prompts the user to apply the N number of sliding touches corresponding to the second predetermined value, and then prompts the user to apply the N number of sliding touches corresponding to the third predetermined value.

FIG. 9 illustrates a flowchart of a method for calibrating the first predetermined value, the second predetermined value, and the third predetermined value. The example method can begin at block S901.

At block S901, the confirmation module 1201 obtains from the memory 12 at regular intervals (such as every month) the sliding distances “S” of the sliding touches corresponding to the first command within a predetermined time duration (such as the previous month). The confirmation module 1201 obtains from the memory 12 at regular intervals (such as every month) the sliding distances “S” of the sliding touches corresponding to the second command within a predetermined time duration (such as the previous month). The confirmation module 1201 obtains from the memory 12 at regular intervals (such as every month) the sliding distances “S” of the sliding touches corresponding to the third command within a predetermined time duration (such as the previous month).

At block S902, the confirmation module 1202 calculates a first calibration value of the sliding distances “S” of the sliding touches corresponding to the first command according to the algorithm. The confirmation module 1202 calculates a second calibration value of the sliding distances “S” of the sliding touches corresponding to the second command according to the algorithm. The confirmation module 1202 calculates a third calibration value of the sliding distances “S” of the sliding touches corresponding to the third command according to the algorithm.

In at least one embodiment, the first calibration value is the average value of the sliding distances “S” of the sliding touches corresponding to the first command. The second calibration value is the average value of the sliding distances “S” of the sliding touches corresponding to the second command. The third calibration value is the average value of the sliding distances “S” of the sliding touches corresponding to the third command.

In another embodiment, the first calibration value is the average value of the sliding distances “S” of the sliding touches corresponding to the first command. The second calibration value is the average value of the sliding distances “S” of the sliding touches corresponding to the second command. The third calibration value is the average value of the sliding distances “S” of the sliding touches corresponding to the third command.

At block S903, the confirmation module 1202 calibrates the first predetermined value according to the first calibration value, calibrates the second predetermined value according to the second calibration value, and calibrates the third predetermined value according to the third calibration value. In other words, the confirmation module 1202 updates the first predetermined value as the first calibration value, updates the second predetermined value as the second calibration value, and updates the third predetermined value as the third calibration value.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An electronic device comprising:
a display screen;
a processor; and
a memory configured to store a plurality of instructions, which when executed by the processor, cause the processor to:
detect a sliding touch operated on the display screen;
confirm a corresponding command according to a start point, an end point, and a sliding distance “S” of the sliding touch operated on the display screen ; and
execute a function of the corresponding command.

2. The electronic device of claim 1, wherein the display screen comprises a designated area; the designated area is located at a bottom portion of the display screen in a current display mode of the display screen; the designated area is defined according to a predetermined shape and size.

3. The electronic device of claim 2, wherein a predetermined distance is defined between a left edge of the display screen and a left edge of the designated area and between a right edge of the display screen and a right edge of the designated area.

4. The electronic device of claim 1, wherein the sliding distance “S” of the sliding touch is calculated according to a coordinate (X1, Y1) of the start point and a coordinate (X2, Y2) of the end point of the sliding touch operated on the display screen the sliding distance “S” is calculated according to the formula:
S=Y2−Y1; OR
S=\sqrt{(X1−X2)²+(Y1−Y2)²}

5. The electronic device of claim 1, wherein the plurality of instructions executed by the processor further cause the processor to:
confirm a first command when the start point of the sliding touch is located within the designated area, the sliding distance “S” is greater than a first predetermined value, and the sliding touch does not hover on the end point;
confirm a second command when the start point of the sliding touch is located within the designated area, the sliding distance “S” is less than the first predetermined value and greater than a second predetermined value, and the sliding touch does not hover on the end point;
confirm a third command when the start point of the sliding touch is located within the designated area, the sliding distance “S” is greater than a third predetermined value, and the sliding touch hovers on the end point for a predetermined time duration.

6. The electronic device of claim 5, wherein the instructions executed by the processor further cause the processor to:
confirm a touch or a sliding touch that occurs only within the designated area to be an ineffective command; wherein:
the sliding touch is confirmed to occur only within the designated area when every coordinate point of the sliding touch is located within the designated area.

7. The electronic device of claim 5, wherein the instructions executed by the processor further cause the processor to:
store, when the sliding touch is confirmed to correspond to the first command, the first command, the sliding distance “S”, and a corresponding time of the first command;
store, when the sliding touch is confirmed to correspond to the second command, the second command, the sliding distance “S”, and a corresponding time of the second command; and
store, when the sliding touch is confirmed to correspond to the third command, the third command, the sliding distance “S”, and a corresponding time of the third command.

8. The electronic device of claim 7, wherein the instructions executed by the processor further cause the processor to:
obtain, at regular intervals, the sliding distances of the sliding touches corresponding to the first command within a predetermined time duration, and calculate a first calibration value of the sliding distances according to a predetermined algorithm;
obtain, at regular intervals, the sliding distances of the sliding touches corresponding to the second command within the predetermined time duration, and calculate a second calibration value of the sliding distances according to the predetermined algorithm;
obtain, at regular intervals, the sliding distances of the sliding touches corresponding to the third command within the predetermined time duration, and calculate a third calibration value of the sliding distances according to the predetermined algorithm; and
update the first predetermined value as the first calibration value, update the second predetermined value as the second calibration value, and update the third predetermined value as the third calibration value.

9. The electronic device of claim 5, wherein the instructions executed by the processor further cause the processor to:
prompt a user to apply an N number of sliding touches to correspond to the first command, detect a first sliding distance “S” of each of the N number of sliding touches to obtain the first sliding distance “S” of each of the N number of sliding touches, and calculate the first predetermined value of the first sliding distance “S” according to the algorithm, N being a positive integer number;
prompt a user to apply an N number of sliding touches to correspond to the second command, detect a second sliding distance “S” of each of the N number of sliding touches to obtain the second sliding distance “S” of each of the N number of sliding touches, and calculate the second predetermined value of the second sliding distance “S” according to the algorithm, N being a positive integer number; and
prompt a user to apply an N number of sliding touches to correspond to the third command, detect a third sliding distance “S” of each of the N number of sliding touches to obtain the third sliding distance “S” of each of the N number of sliding touches, and calculate the third predetermined value of the third sliding distance “S” according to the algorithm, N being a positive integer number.

10. A gesture navigation method implemented in an electronic device comprising a display screen, the gesture navigation method comprising:
detecting a sliding touch operated on the display screen;
confirming a corresponding command according to a start point, an end point, and a sliding distance “S” of the sliding touch; and
executing a function of the corresponding command.

11. The gesture navigation method of claim 10, wherein the display screen comprises a designated area; the designated area is located at a bottom portion of the display screen in a current display mode of the display screen; the designated area is defined according to a predetermined shape and size.

12. The gesture navigation method of claim 11, wherein a predetermined distance is defined between a left edge of the display screen and a left edge of the designated area and between a right edge of the display screen and a right edge of the designated area.

13. The gesture navigation method of claim 10, wherein the sliding distance “S” of the sliding touch is calculated according to a coordinate (X1, Y1) of the start point and a coordinate (X2, Y2) of the end point of the sliding touch operated on the display screen; the sliding distance “S” is calculated according to the formula:
S=Y2−Y1; OR
S=\sqrt{(X1−X2)²+(Y1−Y2)²}

14. The gesture navigation method of claim 10, further comprising:
confirming a first command when the start point of the sliding touch is located within the designated area, the sliding distance “S” is greater than a first predetermined value, and the sliding touch does not hover on the end point;
confirming a second command when the start point of the sliding touch is located within the designated area, the sliding distance “S” is less than the first predetermined value and greater than a second predetermined value, and the sliding touch does not hover on the end point;
confirming a third command when the start point of the sliding touch is located within the designated area, the sliding distance “S” is greater than a third predetermined value, and the sliding touch hovers on the end point for a predetermined time duration.

15. The gesture navigation method of claim 14, further comprising:
confirming a sliding touch that occurs only within the designated area to be an ineffective command; wherein:
the sliding touch is confirmed to occur only within the designated area when every coordinate point of the touch or the sliding touch is located within the designated area.

16. The gesture navigation method of claim 14, further comprising:
storing, when the sliding touch is confirmed to correspond to the first command, the first command, the sliding distance “S”, and a corresponding time of the first command;
storing, when the sliding touch is confirmed to correspond to the second command, the second command, the sliding distance “S”, and a corresponding time of the second command; and
storing, when the sliding touch is confirmed to correspond to the third command, the third command, the sliding distance “S”, and a corresponding time of the third command.

17. The gesture navigation method of claim 16, further comprising:
obtaining, at regular intervals, the sliding distances of the sliding touches corresponding to the first command within a predetermined time duration, and calculating a first calibration value of the sliding distances according to a predetermined algorithm;
obtaining, at regular intervals, the sliding distances of the sliding touches corresponding to the second command within the predetermined time duration, and calculating a second calibration value of the sliding distances according to the predetermined algorithm;
obtaining, at regular intervals, the sliding distances of the sliding touches corresponding to the third command within the predetermined time duration, and calculating a third calibration value of the sliding distances according to the predetermined algorithm; and
updating the first predetermined value as the first calibration value, updating the second predetermined value as the second calibration value, and updating the third predetermined value as the third calibration value.

18. The gesture navigation method of claim 14, further comprising:
prompting a user to apply an N number of sliding touches to correspond to the first command, detecting a first sliding distance “S” of each of the N number of sliding touches to obtain the first sliding distance “S” of each of the N number of sliding touches, and calculating the first predetermined value of the first sliding distance “S” according to the algorithm, N being a positive integer number;
prompting a user to apply an N number of sliding touches to correspond to the second command, detecting a second sliding distance “S” of each of the N number of sliding touches to obtain the second sliding distance “S” of each of the N number of sliding touches, and calculating the second predetermined value of the second sliding distance “S” according to the algorithm, N being a positive integer number; and
prompting a user to apply an N number of sliding touches to correspond to the third command, detecting a third sliding distance “S” of each of the N number of sliding touches to obtain the third sliding distance “S” of each of the N number of sliding touches, and calculating the third predetermined value of the third sliding distance “S” according to the algorithm, N being a positive integer number.
